(19) United States
(12) Patent Application Publication
(10) Pub. No.: US 2010/0166206 A1
(43) Pub. Date: Jul. 1, 2010

(54) DEVICE FOR AND A METHOD OF PROCESSING AUDIO DATA

(75) Inventor: Christophe Marc MACOURS, Hodeige (BE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/647,006

(22) Filed: Dec. 24, 2009

(30) Foreign Application Priority Data
Dec. 29, 2008 (EP) 08173003.8
Mar. 4, 2009 (EP) 09157344.4

(51) Int. Cl. G10K 11/16

(52) U.S. Cl. 381/71.6

(57) ABSTRACT

A device (100) for processing audio data, wherein the device (100) comprises an audio transducer (102, 104) adapted for being operable as a loudspeaker or as a microphone, wherein the audio transducer (102, 104) is adapted for detecting audio data indicative of body noise of a user (106) when being operated as a microphone, and a processing unit (108) adapted for processing the audio data indicative of the body noise of the user (106) for at least partially compensating a wear asymmetry of the audio transducer (102, 104) worn by the user (106) when operating the audio transducer (102, 104) as a loudspeaker for reproducing audio content.

### FIELD OF THE INVENTION

The invention relates to a device for processing audio data. Beyond this, the invention relates to a method of processing audio data. Moreover, the invention relates to a program element. Furthermore, the invention relates to a computer-readable medium.

### BACKGROUND OF THE INVENTION

Audio playback devices become more and more important. Particularly, an increasing number of users buy headphone-based audio playback devices. Speech communication nowadays occurs more and more under noisy circumstances as well as during motion intensive activities. Moreover, a user usually wears earphones while on the move or to enjoy her or his favourite music. Some users also use noise suppressing earphones or headphones in order to reduce ambient noise. The influence of a wear asymmetry (such as a spatial asymmetry between a relative orientation of a left earpiece and a left ear as compared to a relative orientation of a right earpiece and a right ear) on audio playback quality may depend on circumstances such as an anatomy of a user or a manner a user wears headphones.

GB 2,360,165 discloses a method of improving the audibility of sound from a loudspeaker located close to an ear which comprises detecting ambient sounds arriving from other sound sources using a transducer which provides corresponding ambient sound signals, inverting the polarity of said signals, and passing the ambient sound signals through a filter having a transfer function which compensates for the spectral acoustic modification of sounds travelling from the loudspeaker to the ear caused by the proximity of the ear to the loudspeaker, and/or the proximity of the transducer to the head, and combining the filtered ambient sound signals with the signals being fed to the loudspeaker to reduce the audibility of said ambient sounds.

WO 98/41974 discloses a universal active noise reduction apparatus having a headset and a separate electronic sound module, comprising the headset having a housing, whereby the housing has a headband with a first end and a second end; a plurality of ear cups having a microphone means for detecting noise signal and a speaker means for receiving audio signals attached to both ends of the headband; electronic connecting means having a first end and a second end, whereby the first end of the electronic connecting means extends from at least one ear cup of the headband; an adapter connected to the second end of the electronic connecting means, whereby a plurality of male jacks for transmitting the audio signal protrude from the adapter; the electrical sound module contains a noise reduction circuitry means and an amplifier means, whereby the electrical sound module has at least a plurality of female members that interface with the male jacks of the adapter when inserted into the module for transmitting sound means; and optionally a switch means located on the electrical sound module that activates the active noise reduction circuitry means to cancel background noise prior to being transmitted to the ear of the wearer.

However, conventional audio playback systems may suffer from audible artefacts resulting from an unpredictable way a loudspeaker is mounted on a head of a user.

### OBJECT AND SUMMARY OF THE INVENTION

It is an object of the invention to provide an audio system having a proper audio reproduction quality.

In order to achieve the object defined above, a device for processing audio data, a method of processing audio data, a program element and a computer-readable medium according to the independent claims are provided.

According to an exemplary embodiment of the invention, a device (such as a headphone-based audio playback device, for example an audio content playback device having a wear asymmetry compensation feature) for processing audio data is provided, wherein the device comprises an audio transducer adapted for being operable as a loudspeaker or as a microphone (for instance, the audio transducer may be operable as a loudspeaker in a loudspeaker mode and may be operable as a microphone in a microphone mode), wherein the audio transducer is adapted for detecting audio data indicative of body noise of a user when being operated as a microphone, and a processing unit adapted for processing the audio data indicative of the body noise of the user for at least partially compensating a wear asymmetry (or a perceived audio reproduction asymmetry resulting from a wear asymmetry) of the audio transducer worn by the user when operating the audio transducer as a loudspeaker for reproducing audio content.

According to another exemplary embodiment of the invention, a method of processing audio data is provided, wherein the method comprises operating an audio transducer—adapted for being operable as a loudspeaker or as a microphone—as a microphone, detecting audio data indicative of body noise of a user when operating the audio transducer as a microphone, and processing the audio data indicative of the body noise of the user for at least partially compensating a wear asymmetry of the audio transducer worn by the user when (for instance subsequently or simultaneously) operating the audio transducer as a loudspeaker for reproducing audio content.

According to still another exemplary embodiment of the invention, a program element (for instance a software routine, in source code or in executable code) is provided, which, when being executed by a processor, is adapted to control or carry out an audio data processing method having the above mentioned features.

According to yet another exemplary embodiment of the invention, a computer-readable medium (for instance a CD, a DVD, a USB stick, a floppy disk or a harddisk) is provided, in which a computer program is stored which, when being executed by a processor, is adapted to control or carry out an audio data processing method having the above mentioned features.

Data processing for audio calibration purposes which may be performed according to embodiments of the invention can be realized by a computer program, that is by software, or by using one or more special electronic optimization circuits, that is in hardware, or in hybrid form, that is by means of software components and hardware components.

The term “audio transducer” may particularly denote any device that is capable to convert an input signal of one form into an output signal of another form, wherein one of the forms may be an acoustic form and the other one of the forms may be an electric signal. In this case, the system may function as an electroacoustic transducer (converting an electric signal into an acoustic signal when operating the audio transducer as a loudspeaker) or may function as an acoustoelectric transducer (converting an acoustic signal into an electric signal when operating the audio transducer as a microphone). Transducers involving optical signals or other kinds of signals are possible as well. In this context, an acoustic wave may be denoted as a pressure change that moves at the speed of sound.

The term “audio data indicative of body noise of a user” may particularly denote any audio signal which may be detected and which includes information representing the body noise of the user as sensed by the audio transducer when operating the latter as a microphone. Such body noise may particularly include speech, breathing, teeth clacks or the like. It is assumed that in many cases body noise is quite symmetric and can be detected by a left ear audio transducer and by a right ear audio transducer with the same audio characteristic—provided that the left ear audio transducer and the right ear audio transducer are worn symmetrically on a head of a user. If the body-noise-based audio signals captured by the left ear audio transducer and the right ear audio transducer are different, the difference may be considered as a measure for a wear asymmetry (such as a spatial asymmetry between a relative orientation of the left audio transducer and a left ear as compared to a relative orientation of the right audio transducer and a right ear). The captured signals may then be taken as a basis for compensating such a spatial asymmetry for achieving a perceived audio reproduction symmetry.

The term “audio content” may particularly denote any audio piece which is to be reproduced by an audio reproduction device, particularly the loudspeaker of the device. Such audio content may include audio information stored on a storage device such as a CD, a DVD or a harddisk. It may be a music song, speech or the like.

The term “operating an audio transducer as a loudspeaker or as a microphone” may particularly denote the fact that the physical construction of a loudspeaker may be so that it can also serve for detecting acoustic waves. Loudspeakers may depend on an oscillating membrane or the like which is both capable of generating acoustic waves when being activated with an electric signal. On the other hand, such a membrane may also oscillate under the presence of acoustic waves, for instance generated by a user, thereby generating an electric signal to be detected.

According to an exemplary embodiment of the invention, the recognition may be used that audio playback devices such as earpieces are oftentimes worn by a user in an anatomically asymmetric way with respect to a user's ears which may result in an asymmetric audio response, as perceived by the user, during audio playback. By (for instance temporarily) using loudspeakers (usually used for audio reproduction) as microphones for the detection of body noise serving as a fingerprint of a possible wear asymmetry, the degree (or the presence or absence) of such a wear asymmetry may be determined. In other words, an asymmetry of body noise-based audio signals may be used as an indicator of a wear asymmetry of the loudspeakers on the user's head. Such a different fitting response may then be compensated to improve audio reproduction, thereby allowing for a calibration of the audio system in accordance with the measured fitting asymmetry.

According to an exemplary embodiment of the invention, a loudspeaker of an audio content reproduction device may be configured in a way that this loudspeaker can also be controlled to be usable as a microphone, that is not only for emitting sound waves but also for detecting sound waves. Thus, before or during using the device for playing back audio content using the audio transducer as a loudspeaker, it is possible to detect by the microphone body noise signals generated by the user in accordance with a present wearing state of the audio transducer on a body of the user. Without any necessity of additional hardware components or complex measures such as generating of test sounds or the like, and without requiring a user to manually perform any adjustment operation, the system may measure body noise audio waves with one or two or even more loudspeakers of the audio transducer functioning at least part of the time as microphones. The measured body noise signal or signals may then be used for cancellation or suppression of audio reproduction asymmetries due to an asymmetric wear condition, for instance for balancing out differences regarding two earpieces by calculating filter gain values for filtering the audio content signals before reproduction to, if necessary, compensate effects of a way a user wears an audio content reproduction device.

According to an exemplary embodiment of the invention, a system for automatic calibration of a feedforward Active Noise Reduction (ANR) headset without the need of extra hardware may be provided. The loudspeakers may be used as microphones and the left/right differences may be calculated based on sound sources produced by the listener.

In an embodiment, a method of adjusting or calibrating a headset- or earphone-based active noise cancellation system may be provided wherein filter gains may be changed in response to body noises or speech produced by the wearer or user. Such a calibration process may be performed dependent upon body noises generated by the wearer or user.

In the following, further exemplary embodiments of the device will be described. However, these embodiments also apply to the method, to the program element and to the computer-readable medium.

The device may comprise a headset having a first earpiece and a second earpiece, the first earpiece being positionable adjacent to a first ear of the user and the second earpiece being positionable adjacent to a second ear of the user when the headset is mounted on a head of the user. In an embodiment, such a headset may comprise a pair of headphones or earphones having loudspeakers operable as well as microphones. An optional further microphone may be provided in addition and may be arranged close to a mouth of a user. Headphones may comprise a pair of speakers on, over or in the ears so that only the wearer can hear a sound. Earphones may be denoted as small speakers worn just over or in the ears. Particularly when such earpieces are worn at least partially within the ear, the present inventor has recognized that the influence of a wear asymmetry on the quality of the perceived audio content during playback may be significant and may depend on the way how the earpieces are worn. In such a scenario, a calibration by (for instance temporarily) operating loudspeakers as microphones for cancellation or suppression of audible differences due to a wear asymmetry using body noise signals as a probe indicative of a coupling response may be particularly advantageous and may be performed before each use of the device or when using the device for the first time. It is also possible to perform such a calibration during the playback of audio information.

The transducer may comprise a first audio transducer section (such as a first loudspeaker operable as a first microphone) arranged at the first earpiece and may comprise a second audio transducer section (for instance comprising a second loudspeaker operable as a second microphone) arranged at the second earpiece, each of the first audio transducer section and the second audio transducer section being adapted for being operable selectively as a loudspeaker or as a microphone.

Still referring to the previous embodiment, the processing unit (which may have processing capabilities and may be a CPU, central processing unit, or a microprocessor) may be adapted for processing the audio data by determining a difference between the audio data as detected by the first audio transducer section and the second audio transducer section. Therefore, a different influence of body noise and/or other surrounding sound on the two audio transducer sections resulting from asymmetric wear conditions may be balanced out by estimating the difference and by calculating manipulating signals for manipulating audio playback data for the two ears in an asymmetric way to thereby compensate for such differences.

The processing unit may be adapted for processing the audio data by determining a difference in energy levels (for instance power levels) between the audio data detected by the first audio transducer section and the second audio transducer section in a predefined frequency band. For instance, the difference determination may be performed selectively in an audible frequency band thereby concentrating on a frequency section being a source of audible artefacts. It is also possible that specific portions of the audible spectrum, such as a bass section, a middle frequency section or a treble section may be specifically manipulated to improve the reproduced audio quality by cancelling or suppressing spatially asymmetric wear conditions on the sound quality being reproduced.

The processing unit may also be adapted for processing the audio data for compensating the determined difference. Thus, the processing may be performed so that the subjectively perceivable quality is improved for the two earpieces.

The processing unit may be adapted for feeding back (or supplying) filter gain values as the processed audio data to the audio transducer for reproducing audio content in accordance with the one or more filter gain values to thereby suppress audible left-right differences regarding the reproduction of the audio content resulting from the wear asymmetry of the audio transducer worn by the user. Such filter gain values may be values with which the audio content to be reproduced is filtered before such a filtered signal is used for generating acoustic waves by the loudspeaker. The calculation of gain values, particularly of two gain values (one for each ear), allows to perform the compensation of left-right wear asymmetry indicated by the detected body noise with reasonable computational burden.

The processing unit may be adapted for feeding back (or supplying) frequency-dependent gain values as the processed audio data to the audio transducer. Thus, for each of a reproduction frequency particularly in the audible range, such a gain value may be calculated so that the compensation may be performed in accordance with a frequency-dependent manipulation function with which a spectrum to be reproduced may be manipulated in a frequency-dependent manner. This allows to significantly improve the quality of the audio data to be reproduced.

More specifically, the processing unit may be adapted for feeding back (or supplying) different filter gain values to the first audio transducer section and the second audio transducer section for operation as loudspeakers. Thus, spatial asymmetry of body anatomy or a way of wearing earpieces may be compensated by spatially asymmetric filtering for the two earpieces.

The audio transducer may be adapted for being operable simultaneously as a loudspeaker and as a microphone. In such an embodiment, the calibration may be performed during reproducing sound, therefore allowing to dynamically adapt filter gain values to modified external circumstances such as modified playback properties or wearing conditions of a headset, headphones or an earpiece. In such a scenario, an entity (such as an audio filter or an audio manipulator) may be provided which allows the system to distinguish between data originating from the audio content and data originating from body noise.

For instance, this may be achieved by using an acoustic echo canceller (AEC) adapted for cancelling a contribution of the reproduced audio content from a determined signal (when operating the loudspeaker as a microphone) to obtain the audio data indicative of body noise of the user only. Therefore, such an acoustic echo canceller may remove audio content contributions from a detected signal so that an extraction of the body noise related audio data is possible even during simultaneously playing back audio content. Echo cancellation may include to isolate and remove unwanted signal energy created by echoes of a reproduced audio signal.

In an alternative embodiment, the device may be adapted for operating the audio transducer as a microphone only when it is not simultaneously operated as a loudspeaker. For instance, before using the device for playing back the audio content, the calibration procedure may be performed. This may allow to perform the calibration without the possibly disturbing influence of reproduced audio content.

In one embodiment, one and the same physical structure constituting the audio transducer is adapted for providing both the loudspeaker and the microphone function (in dependence of an operation mode of this common physical structure). In another embodiment, the audio transducer comprises a first physical structure adapted for providing the loudspeaker function and comprises a second physical structure (which is different and separate from the first physical structure) adapted for providing the microphone function. Hence, the transducer used to sense body noise does not have to be the same transducer playing back the audio signal (although this is a preferred embodiment, as it brings a very high benefit). A separate microphone placed close to the loudspeaker can also be used (such as microphone 206 in FIG. 3) in an embodiment of the invention.

For instance, the device according to the invention may be realized as one of the group consisting of a mobile phone, a headset, a headphone playback apparatus, a hearing aid, a television device, a video recorder, a monitor, a gaming device, a laptop, an audio player, a DVD player, a CD player, a harddisk-based media player, a radio device, an internet radio device, a public entertainment device, an MP3 player, a car entertainment device, a medical communication system, a medical device, a body-worn device, a speech communication device, a home cinema system, a home theatre system, a flat television apparatus, an ambiance creation device, a studio recording system, or a music hall system. However, these applications are only exemplary, and other applications in many fields of the art are possible. In an embodiment, the device may be used for Active Noise Reduction (ANR) headsets of an in-ear feedforward type.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a device for processing audio data according to an exemplary embodiment of the invention.

FIG. 2 illustrates a feedforward Active Noise Reduction (ANR) system.

FIG. 3 illustrates a feedback Active Noise Reduction (ANR) system according to an embodiment of the invention.

FIG. 4 illustrates a device for processing audio data according to another exemplary embodiment.

FIG. 5 and FIG. 6 are diagrams illustrating a frequency spectrum of speech recording using in-ear loudspeakers as microphones according to an exemplary embodiment and illustrating different fitting scenarios and different impacts on left/right differences.

FIG. 7 shows a calibration block of a device for processing audio data according to an exemplary embodiment of the invention.

### DESCRIPTION OF EMBODIMENTS

The illustration in the drawing is schematically. In different drawings, similar or identical elements are provided with the same reference signs.

In the following, some basic recognitions of the present inventors will be mentioned based on which exemplary embodiments of the invention have been developed.

Active Noise Reduction (ANR) headsets shall reduce the exposure to ambient noise by playing so-called “anti-noise” through headset loudspeakers. A basic principle is that the ambient noise is picked up by a microphone, filtered and phase-reversed with an ANR filter, and sent back to the loudspeaker. In case of a feedforward ANR, the microphone may be arranged outside the ear cup. In case of a feedback ANR, the microphone may be arranged inside the ear cup.

In portable/mobile applications, a possible implementation is the in-ear feedforward analogue ANR which may have the same form factor as traditional earphones and may be easier to design than feedback ANR in-ear headsets, wherein the mounting of a microphone on the inner side of the ear may be mechanically and acoustically difficult.

However, in-ear ANR headsets, more than full-size ANR headsets, may suffer from a lack of repeatability in the coupling with the ears. This may have particularly the following consequences:

A transfer function from the loudspeaker to the ear canal may be not constant. This may affect the bass response first (reduced pressure coupling).

Passive attenuation (defined as the sound blocking effect due to the presence of the headset on the ears) may be also strongly reduced.

An impact of this imperfect fitting on the in-ear feedforward ANR performance may be large, because an ANR filter may be precisely calculated in the design phase of the headset based on those two transfer functions. A result may be that an imperfect fitting of the headset in the ear may lead to a reduced ANR effect or even to an amplification of the ambient noise.

More generally, a feedforward ANR filter may depend on the following elements:

Headphone acoustics which may be different for each headset type. This may be done during the development phase of the ANR headset and is then not changing in the life of the headset.

Loudspeaker and microphone tolerances may be different for each headset sample. This may be controlled by selecting low-tolerance components or by doing a sample calibration in the factory.

Fitting in the ears may be different for each ear user, or may be even different between each use of the headset.

The latter element may be the most critical as it may be unpredictable. Even a properly calibrated in-ear ANR headset in the factory may suffer from poor performance once in the user's ears. Such differences may be compensated by means of two gains, one for the left ear and one for the right ear. Indeed, differences observed in the acoustical transfer functions between the loudspeaker and the ear canal for different fitting conditions may have the form of a frequency independent gain up to around 2 kHz. This is exactly the frequency range where the ANR effect may be active.

Hence, it can be concluded that the calibration of ANR filter to varying fitting conditions can be done by means of two gains, one for the left ear and one for the right ear.

An automatic way to tackle the problem is to put an additional internal microphone in the headset. This microphone can be used to identify the acoustical transfer function between the loudspeaker and the microphone and automatically improve or optimize the ANR filter and gain to the fitting conditions.

However, mounting an additional internal microphone in in-ear headsets may be mechanically and acoustically difficult.

Another way to tackle the calibration problem is to allow the end-user to manually adjust the left and right ANR filter gains so as to improve or maximize the ANR effect. This may partly compensate imperfect fitting, but does not lead to optimal results as left/right fitting differences are not compensated. An additional control to tune the left and right gains differently may be considered as inconvenient for an end-user.

Hence, the performance of the above-mentioned concepts for in-ear ANR headsets may suffer from a lack of repeatability in the fitting of the earpieces into the ears. An individual calibration may be appropriate to get optimal performance. In summary, no conventional technique enables an automatic calibration of the left and right ANR filter gains without the need of extra internal microphones.

In an embodiment of the present invention, a system for automatically calibrating the left and right in-ear feedforward Active Noise Reduction (ANR) filter gains may be provided in order to compensate for fitting asymmetries of in-ear headphones in the listener's ears. This does not require any additional hardware since the loudspeakers may be used as microphones and the left/right differences may be calculated based on sound sources (speech, teeth clacks, etc.) produced by the user.

FIG. 1 illustrates a device 100 for processing audio data which comprises two audio transducer sections 102, 104 adapted for being operable selectively as a loudspeaker and/or as a microphone (depending on an operation mode), wherein the audio transducer sections 102, 104 are adapted for detecting audio data (such as corresponding electric signals) indicative of body noise of a user 106 when being operated as a microphone. When the user 106 carries the audio transducer sections 102, 104, the audio transducer sections 102, 104 operated as loudspeakers may generate acoustic waves perceived by the user 106 which allows the user 106 to listen to audio content stored on an audio data storage device 130 such as a harddisk, a CD, a DVD, etc. For this purpose, electronic audio signals 132, 133 supplied from the harddisk 130 may be converted by the audio transducer sections 102, 104 into acoustic waves perceived by respective ears 116, 118 of the user 106.

However, it can happen that the user 106 carries the audio transducer sections 102, 104 asymmetrically with respect to the ears 116, 118. More precisely, a spatial relation between audio transducer section 102 and the ear 116 may differ from a spatial relation between audio transducer section 104 and the ear 118, for example since the user 106 has not attached the audio transducer sections 102, 104 symmetrically on the head or the head is anatomically not completely symmetric. If for example a distance between audio transducer section 102 and the ear 116 is smaller than a distance between audio transducer section 104 and the ear 118, the same reproduced sound will sound louder for ear 116 than for ear 118.

Moreover, the human user 106 tends to continuously generate body noise for instance by speaking, breathing or teeth clacking which has in many cases a spatially symmetric characteristic. If for example the distance between audio transducer section 102 and the ear 116 is smaller than the distance between audio transducer section 104 and the ear 118, audio signals indicative of the body noise may have a larger amplitude at the position of the audio transducer section 102 as compared to a position of the audio transducer section 104. Therefore, an audio signal generated by body noise may be taken as an indicator for the described wear asymmetry.

A microprocessor 108 operating as a processing unit is adapted for processing audio data (resulting from the body noise) recorded by the audio transducer sections 102, 104 presently operating as microphones for acoustically compensating a wear asymmetry of the audio transducers 102, 104 worn by the user 106. Microprocessor 108 is adapted for feeding back the processed audio data in the form of electronic control or filter signals to the audio transducer sections 102, 104 for compensating the wear asymmetry detected based on a possible asymmetry of body noise signals as captured by the audio transducer sections 102, 104. When operating the audio transducer sections 102, 104 as loudspeakers for reproducing the audio content stored on the harddisk 130, such audio content may be manipulated by the electronic control or filter signals so as to compensate wear asymmetry measured by body noise detection. In other words, audio data representing the body noise of the user 106 may be provided in the form of electronic signals 134, 136 to the processing unit 108. These electronic signals 134, 136 are generated by the audio transducer sections 102, 104 when being operated as microphones, that is when the audio transducer sections 102, 104 capture acoustic waves representing body noise and convert them into electric signals indicative of the degree of asymmetry.

The control unit 108 may then control the harddisk 130, by means of one or more signals 138 so that the reproduction of the audio content is manipulated accordingly and asymmetric wear conditions are compensated. Alternatively, as shown as dashed lines in FIG. 1, the control unit 108 may also be adapted to generate control data 140, 142 by which the audio content signals 132, 133 sent from the harddisk 130 to the audio transducers 102, 104 for reproduction are manipulated. Thus, the dashed lines 140, 142 are alternatives to the provision of the signal 138.

As can further be taken from FIG. 1, a user interface 148 may be provided in bidirectional communication with the processing unit 108 allowing a user to control an operation mode of the device 100, for instance may adjust volume, etc. of the playback. By the input/output unit 148, the user may provide control commands to the processing unit 108 and may be supplied with information regarding a present operation mode of the device 100. Hence, the user interface 148 may include input elements such as buttons or the like and may also comprise a display unit such as a liquid crystal display (LCD).

More specifically, the device 100 comprises a headset 110 having a first earpiece 112 and a second earpiece 114, the first earpiece 112 being positioned adjacent to the first ear 116 of the user 106 and the second earpiece 114 being positioned adjacent to the second ear 118 of the user 106 when the headset 110 is mounted on a head of the user 106, as shown in FIG. 1.

The first audio transducer section 102 is arranged at the first earpiece 112, and the second audio transducer section 104 is arranged at the second earpiece 114. Each of the first audio transducer section 102 and the second audio transducer section 104 is adapted for being selectively operable as a loudspeaker or as a microphone.

The processing unit 108 may determine, by analyzing the signals 134 and 136, a difference between the influence of the body noise detected by the first audio transducer section 102 and the second audio transducer section 104, for instance due to an asymmetric wearing condition of the headset 110 by the user 106. Differences regarding energy levels between the audio data 136, 134 detected by the first audio transducer section 102 and the second audio transducer section 104 in an audible frequency band may be determined and equilibrated at least partially. Hence, such differences may be compensated by means of the control signal(s) 138 or 140, 142 which may manipulate the audio content stored in the harddisk 130 before reproduction on the individual loudspeakers 102, 104. Particularly, different filter gain values may be supplied to the different audio transducer sections 102, 104.

The processing unit 108 may also serve as an acoustic echo canceller for cancelling a contribution of the reproduced audio content from a determined signal to obtain the audio data indicative of the body noise of the user only. This may further refine the accuracy of the estimation of a wear asymmetry by analyzing body noise signals. Acoustic echo cancellation may be performed when the calibration procedure, that is the determination of the values 140, 142, for instance, is performed during playing back the audio content 132, 133.

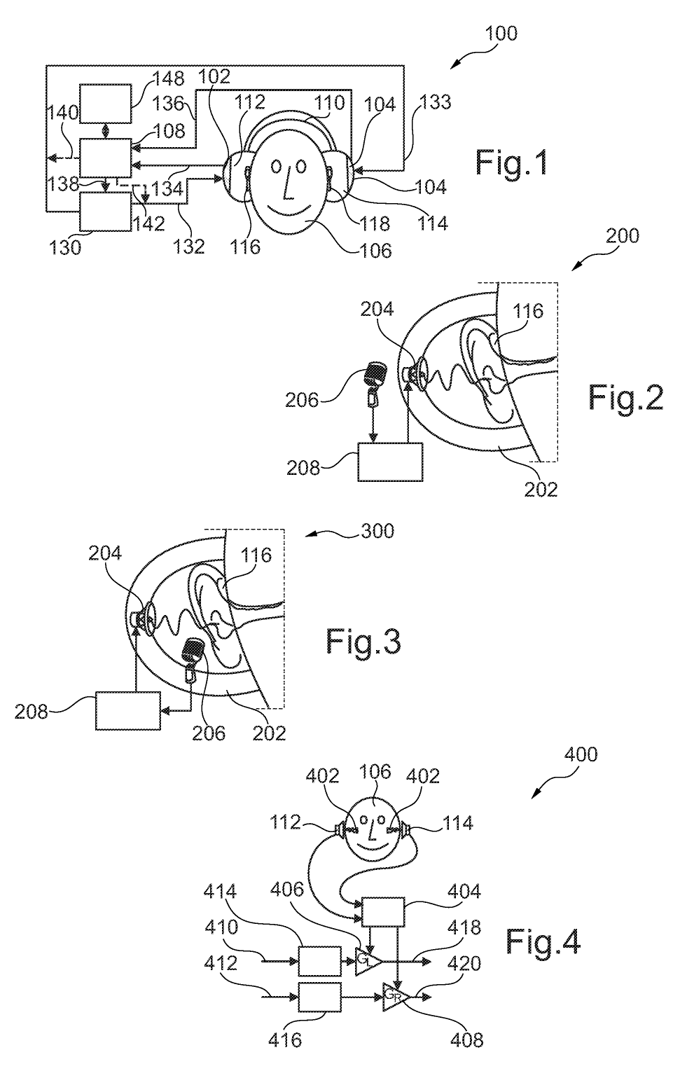

FIG. 2 shows a feedforward active noise reduction headset 200 in which an ear cup 202 is attached on the ear 116. In FIG. 2, the loudspeaker 204 is arranged within the ear cup 202, whereas a separate microphone 206 for detecting external noise is arranged outside of the ear cup 202. An active noise reduction unit 208 may compensate for body noise signals detected by the separate microphone 206. In contrast to the system of FIG. 2, embodiments of the invention use a common audio transducer 102, 104 in which microphone 206 and loudspeaker 204 are arranged as the same entity operated in two different ways.

In contrast to the feedforward ANR system 200, a feedback ANR system 300 according to an embodiment of the invention as shown in FIG. 3 incorporates both the loudspeaker 204 as well as the microphone 206 within the ear cup 202.

Other embodiments of the invention operate for instance similar to the feedback geometry of FIG. 3, however with the microphone 206 and the loudspeaker 204 arranged as a single common shared unit.

FIG. 4 shows an audio playback device 400 according to another exemplary embodiment of the invention.

Signals indicative of body noise generated by a user 106 and denoted schematically with reference numeral 402 are applied via the earpieces 112, 114 to an active noise reduction calibration entity 404. The active noise reduction calibration entity 404 calculates, based on the signals indicative of the body noise 402 provided by the earpieces 112, 114, gain values G_{L} and G_{R} to be supplied to amplifiers 406, 408 respectively. Based on these gain values G_{L}, G_{R} which are characteristic for a wear asymmetry of the earpieces 112, 114 indicated by the body noise 402 as perceived via the earpieces 112, 114, a left earpiece audio content 410 and a right earpiece audio content 412 are correspondingly amplified differently. Filter units 414 or 416, respectively, may be implemented as well. Hence, audio output signals 418, 420 may be then forwarded to the earpieces 112 and 114 for playback of the audio content with artefacts from wear asymmetry being suppressed.

The listener 106 is wearing an ANR headset 112, 114 where the loudspeakers are used as microphones. Sound produced by the user 106 (such as voiced speech or teeth clacking against each other) is captured by the loudspeakers and processed through the ANR calibration unit 404, which calculates the required gain difference between the left and right ears and adjusts accordingly the ANR filter gains G_{L} and G_{R}.

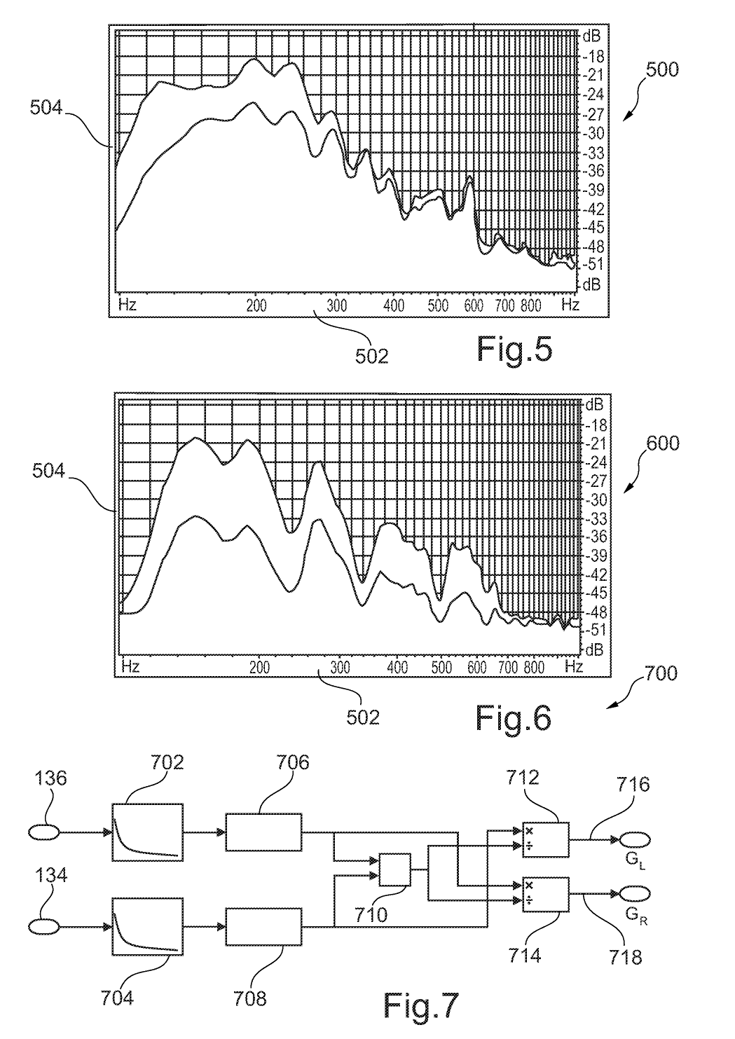

FIG. 5 shows a diagram 500 and FIG. 6 shows a diagram 600 each having an abscissa 502 along which a frequency is plotted in Hertz. Along an ordinate 504, signal intensities are plotted. FIG. 5 and FIG. 6 each show two different channels (left/right) of an audio playback system, wherein FIG. 5 and FIG. 6 illustrate two different wearing or fitting scenarios according to which a headphone is mounted on a head of a user. Hence, FIG. 5 and FIG. 6 illustrate the impact of the wearing condition (and particularly of a wear asymmetry) on the left/right differences.

FIG. 5 and FIG. 6 show the frequency response of user's speech recorded using the in-ear loudspeakers as microphones for two different fittings. In FIG. 6, the right loudspeaker fitting is looser, which strongly increases the relative left/right difference. By comparing the energy levels of the left and right recordings in a specific frequency band, it is possible to derive the appropriate ANR gain correction.

FIG. 7 shows an active noise reduction calibration block 700 according to an exemplary embodiment of the invention.

As can be taken from FIG. 7, a left speaker signal 136 and a right speaker signal 134 are supplied to respective low pass filters 702, 704. Low pass filters 702, 704 may have a cut-off at 1 kHz and may operate in accordance with a Butterworth filter characteristics. The filter outputs may be supplied to a root mean square calculation unit 706 or 708. The outputs of the units 706, 708 may then be supplied to a maximum determination unit 710 and to a left signal generation unit 712 or a right signal generation unit 714. These units 712, 714 may operate on the outputs of the units 706, 708 and 710 in the shown way and generate output signals 716, 718 respectively which may then be indicative of the gain values G_{L} or G_{R}.

Hence, FIG. 7 shows a way to implement the ANR calibration block 404 of FIG. 4. It compares the energy level contained in a specific frequency range between the left and right loudspeaker inputs.

The ANR filter calibration can be done in the frequency domain (that is frequency dependent ANR Gain) based on the frequency dependency of the left/right differences. The same process can be executed during the use of the ANR headset. In that case, the captured loudspeaker signals also contain the signals (anti-noise plus music) to be played on the loudspeakers. This can be removed by means of an Acoustic Echo Canceller (AEC).

It should be noted that the term “comprising” does not exclude other elements or features and the “a” or “an” does not exclude a plurality. Also elements described in association with different embodiments may be combined.

It should also be noted that reference signs in the claims shall not be construed as limiting the scope of the claims.

1. A device for processing audio data, comprising:
an audio transducer operable as at least one of a loudspeaker and a microphone, wherein the audio transducer is adapted for detecting audio data indicative of body noise of a user when being operated as a microphone; and
a processing unit adapted for processing the audio data indicative of the body noise of the user for at least partially compensating for a wear asymmetry of the audio transducer worn by the user when operating the audio transducer as a loudspeaker for reproducing audio content.

2. The device according to claim 1, further comprising a headset, the headset having a first earpiece and a second earpiece, the first earpiece being positionable on or in a first ear of the user and the second earpiece being positionable on or in a second ear of the user.

3. The device according to claim 2, wherein the audio transducer comprises a first audio transducer section arranged at the first earpiece and a second audio transducer section arranged at the second earpiece, each of the first audio transducer section and the second audio transducer section being operable as a loudspeaker or as a microphone.

4. The device according to claim 3, wherein the processing unit is adapted for processing the audio data indicative of body noise of the user by determining a difference between the audio data detected by the first audio transducer section and the audio data detected by the second audio transducer section.

5. The device according to claim 3, wherein the processing unit is adapted for processing the audio data indicative of body noise of the user by determining a difference in energy levels between the audio data detected by the first audio transducer section and the audio data detected by the second audio transducer section in a predefined frequency band.

6. The device according to claim 4, wherein the processing unit is adapted for processing the audio data to at least partially compensate the determined difference.

7. The device according to claim 1, wherein the processing unit is adapted for feeding back at least one filter gain value as the processed audio data to the audio transducer for reproducing audio content in accordance with the at least one filter gain value to thereby suppress audible left-right differences regarding the reproduction of audio content resulting from the wear asymmetry of the audio transducer worn by the user.

8. The device according to claim 7, wherein the processing unit is adapted for feeding back at least one frequency-dependent gain value as the processed audio data to the audio transducer.

9. The device according to claim 4, wherein the processing unit is adapted for feeding back separate filter gain values to the first audio transducer section and to the second audio transducer section for operation as loudspeakers.

10. The device according to claim 1, wherein the audio transducer is operable simultaneously as a loudspeaker and as a microphone.

11. The device according to claim 10, further comprising an acoustic echo canceller adapted for removing the reproduced audio content from an audio signal determined by the audio transducer to derive a pure audio data indicative of body noise of the user.

12. The device according to claim 1, wherein either:
a same physical structure constituting the audio transducer provides both the loudspeaker and the microphone function; and
the audio transducer comprises a first physical structure adapted for providing the loudspeaker function and a second physical structure adapted for providing the microphone function.

13. The device according to claim 1, wherein the device is included in at least one of the group consisting of a mobile phone, a headset, a headphone playback apparatus, a hearing aid, a television device, a video recorder, a monitor, a gaming device, a laptop computer, an audio player, a DVD player, a CD player, a harddisk-based media player, a radio device, an internet radio device, a public entertainment device, an MP3 player, a car entertainment device, a medical communication system, a medical device, a body-worn device, a speech communication device, a home cinema system, a home theatre system, a flat panel television apparatus, an ambiance creation device, a studio recording system, and a music hall system.

14. A method of processing audio data, comprising:
operating an audio transducer, adapted for being operable as at least one of a loudspeaker and a microphone, as a microphone;
detecting audio data indicative of body noise of a user when operating the audio transducer as the microphone; and
processing the audio data indicative of the body noise of the user for at least partially compensating a wear asymmetry of the audio transducer worn by the user when operating the audio transducer as a loudspeaker for reproducing audio content.

15. A computer-readable medium, in which a computer program of processing audio data is stored, which computer program, when being executed by a processor, is implements a method according to claim 14.

16. A program element of processing audio data, which program element, when being executed by a processor, implements a method according to claim 14.

17. The device according to claim 4, wherein the audio data detected by the first audio transducer section and the audio data detected by the second transducer section are in an audible frequency band, more particularly in a predefined portion of an audible frequency band.

18. The device according to claim 17, wherein the audio data detected by the first audio transducer section and the audio data detected by the second transducer section are in a predefined portion of the audible frequency band.
